(19) United States
(12) Patent Application Publication
(10) Pub. No.: US 2023/0305113 A1
(43) Pub. Date: Sep. 28, 2023

(54) LIGHT DETECTION DEVICE

(71) Applicant: DENSO CORPORATION, Kariya-city (JP)

(72) Inventors: KAZUHISA ONDA, Kariya-city (JP); KENICHI YANAI, Kariya-city (JP); HITOSHI YAMADA, Kariya-city (JP)

(21) Appl. No.: 18/308,582

(22) Filed: Apr. 27, 2023

Related U.S. Application Data
(63) Continuation of application No. PCT/JP2021/038590, filed on Oct. 19, 2021.

(30) Foreign Application Priority Data
Nov. 3, 2020 (JP) 2020-184034

(51) Int. Cl. G01S 7/481; G01S 17/931; G02B 26/10

(52) U.S. Cl. CPC G01S 7/4815; G01S 7/4817; G01S 17/931; G02B 26/105; G02B 27/0966

(57) ABSTRACT

A LiDAR device is a light detection device including a light-emitting unit, a light-receiving unit, and an optical unit. In the light-emitting unit, a plurality of VCSEL elements respectively emitting a beam are arranged along a light source array direction. The light-receiving unit receives a reflected beam from a measurement area. The optical unit includes a first optical element and a second optical element, and forms a projected beam extending along the light source array direction. The first optical element has a negative power along a transmission direction of the beam on a main scanning plane that is orthogonal to the light source array direction. The second optical element is positioned behind the first optical element, and has a positive power along the transmission direction on the main scanning plane that is orthogonal to the light source array direction.

### CROSS REFERENCE TO RELATED APPLICATION

The present application is a continuation application of International Patent Application No. PCT/JP2021/038590 filed on Oct. 19, 2021, which designated the U.S. and claims the benefit of priority from Japanese Patent Application No. 2020-184034 filed on Nov. 3, 2020. The entire disclosures of all of the above applications are incorporated herein by reference.

### TECHNICAL FIELD

The disclosure according to this specification relates to a light detection device.

### BACKGROUND

An optical device including light-emitting elements has been used for measurement of a distance from an object.

### SUMMARY

According to an aspect of the present disclosure, a light detection device includes a light-emitting unit including a plurality of light emitters, an optical unit positioned on an optical path of the beam, and a light-receiving unit configured to receive a return light of the projected beam.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of a LiDAR device according to a first embodiment of the present disclosure;

FIG. 2 is a plan view showing a configuration of a VCSEL array;

FIG. 3 is a perspective view showing a lens configuration of an optical unit;

FIG. 4 is a diagram for explaining an optical action of the optical unit on a main scanning plane;

FIG. 5 is a diagram for explaining the optical action of the optical unit on a sub-scanning plane;

FIG. 6 is a diagram showing a configuration of the LiDAR device according to a second embodiment of the present disclosure;

FIG. 7 is a diagram for explaining a structure of the optical unit on the main scanning plane;

FIG. 8 is a diagram for explaining a structure of the optical unit on the sub-scanning plane;

FIG. 9 is a diagram showing a configuration of the LiDAR device according to a third embodiment of the present disclosure;

FIG. 10 is another diagram for explaining a structure of the optical unit on the main scanning plane;

FIG. 11 is another diagram for explaining a structure of the optical unit on the sub-scanning plane;

FIG. 12 is a diagram showing a configuration of the LiDAR device according to a fourth embodiment of the present disclosure;

FIG. 13 is a diagram showing a configuration of the LiDAR device according to a fifth embodiment of the present disclosure;

FIG. 14 is a diagram showing a configuration of the LiDAR device according to a sixth embodiment of the present disclosure;

FIG. 15 is a diagram for explaining the optical action of a homogenizer;

FIG. 16 is a diagram showing a configuration of the LiDAR device according to Modification 1; and

FIG. 17 is a diagram showing Modifications 2 to 7 of the VCSEL array.

### DETAILED DESCRIPTION

Hereinafter, examples of the present disclosure will be described.

According to an example of the present disclosure, an optical device that includes a light source, in which a plurality of light-emitting elements are arranged one-dimensionally at predetermined intervals, and a line generator that converts the light from the plurality of light-emitting elements into line light. The optical device projects the line light toward a measurement target. The line generator includes a plano-convex cylindrical lens having a convex surface.

For example, when line light is projected toward a distant measurement target, the spread of the line light can cause speckle noise. Therefore, in order to suppress the increase of the width of the line light, it is assumable to reserve a long focal length of the line generator by adjusting the lens shape of the plano-convex cylindrical lens. However, when a long focal length is reserved, the light source needs to be arranged at a position distant from the line generator, which may increase the size of the optical system.

According to an example of the present disclosure, a light detection device, which includes:
a light-emitting unit including a plurality of light emitters arranged along a specific array direction and configured to emit a beam;
an optical unit positioned on an optical path of the beam emitted from the light-emitting unit and configured to form a projected beam extending along the specific array direction; and
a light-receiving unit configured to receive a return light of the projected beam projected to a measurement area.

The optical unit includes:
a first optical element having a negative power along a beam transmission direction in a specific section that is orthogonal to the specific array direction; and
a second optical element positioned behind the first optical element and having a positive power along the transmission direction in the specific section.

In this example, the first optical element having a negative power is arranged before the second optical element having a positive power along the specific section orthogonal to the specific array direction of the light-emitting units. Therefore, a principal plane made of a combination of the first optical element and the second optical element is defined behind the second optical element when observed in the specific section. According to the above, it is possible to realize an arrangement in which the light-em itting unit is brought closer to the optical unit while reserving the focal length of a group of the optical elements. As a result, it is possible to suppress the increase of the size of the optical system while suppressing the increase of the width of the line-shaped projected beam extending in the specific array direction.

Hereinafter, embodiments of the present disclosure are described with reference to the drawings. In the following description, the same reference symbols are assigned to corresponding components in each of the embodiments in order to avoid repetitive descriptions. In each of the embodiments, when only a part of the configuration is described, the remaining part of the configuration may adopt corresponding parts of other embodiments. In addition to the combinations of configurations specifically shown in various embodiments, the configurations of various embodiments are partly combinable even when not explicitly suggested, unless such combinations are contradictory. Moreover, combinations of configurations mentioned in the embodiments and modifications, which are not explicitly disclosed are assumed to be encompassed in following description.

### First Embodiment

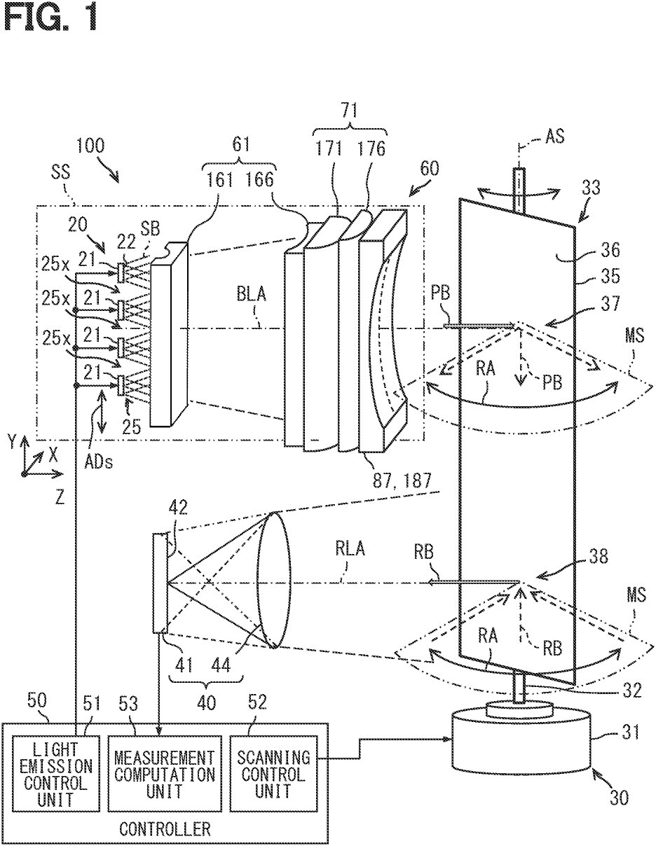

A LiDAR device 100, or a Light Detection and Ranging/Laser Imaging Detection and Ranging device 100, according to the first embodiment of the present disclosure shown in FIGS. 1 to 5, functions as a light detection device. The LiDAR device 100 is mounted on a vehicle as a mobile object. The LiDAR device 100 is arranged, for example, in a front portion, left and right side portions, a rear portion, on a roof of the vehicle, or the like. The LiDAR device 100 scans a predetermined field area (hereinafter referred to as a measurement area) near the vehicle outside the device with a projected beam PB. The LiDAR device 100 detects a return light (hereinafter referred to as reflected beam RB) resulting from reflection of the projected beam PB irradiated to the measurement area and reflected by a measurement object. Light in the near-infrared area, which is difficult for humans in the outside field to visually recognize, is normally used as the projected beam PB.

The LiDAR device 100 can measure the measurement object by detecting the reflected beam RB. The measurement of the measurement object includes, for example, measurement of a direction (i.e., a relative direction) in which the measurement object exists, measurement of a distance (i.e., a relative distance) from the LiDAR device 100 to the measurement object, and the like. Typical objects to be measured by the LiDAR device 100 applied to a vehicle include moving objects such as pedestrians, cyclists, non-human animals, and other vehicles, or structures such guardrails (i.e., railings on roadside), road signs, roadside structures and buildings, a stationary object such as a fallen object and the like.

Regarding the vehicle-mounted LiDAR device 100, unless otherwise described, the front, rear, up, down, left and right directions are defined with reference to a vehicle standing still on a horizontal plane. In addition, the horizontal direction indicates a tangential direction tangential to the horizontal plane, and the vertical direction indicates a direction orthogonal to the horizontal plane.

The LiDAR device 100 includes a light-emitting unit 20, a scanning unit 30, a light-receiving unit 40, a controller 50, an optical unit 60, and a housing that accommodates these components.

The housing forms an outer shell of the LiDAR device 100. The housing is composed of a light-shielding container, a cover panel, and the like. The light-shielding container is made of a light-shielding synthetic resin, metal, or the like, and has a substantially rectangular parallelepiped box shape as a whole. An accommodation chamber and an optical window are formed in the light-shielding container. The accommodation chamber accommodates main optical components of the LiDAR device 100. The optical window is a rectangular opening that allows both the projected beam PB and the reflected beam RB to travel back and forth between the accommodation chamber and the measurement area. The cover panel is a lid made of translucent material such as synthetic resin, glass or the like. The cover panel is formed with a transmitting portion that transmits the projected beam PB and the reflected beam RB. The cover panel is attached to the light-shielding container in such a manner that the transmitting portion covers the optical window of the light-shielding container. The housing is held by the vehicle with the longitudinal direction of the optical window aligned with the horizontal direction of the vehicle.

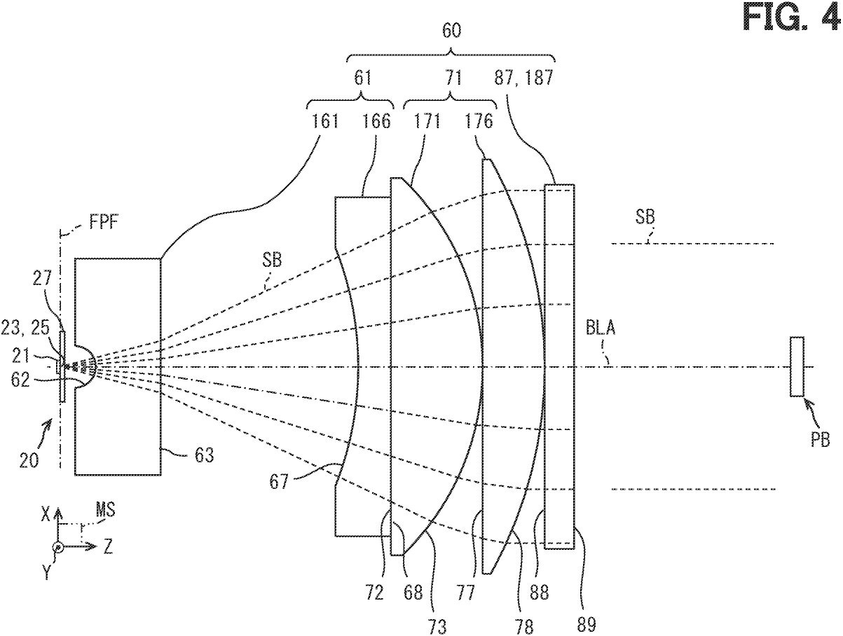

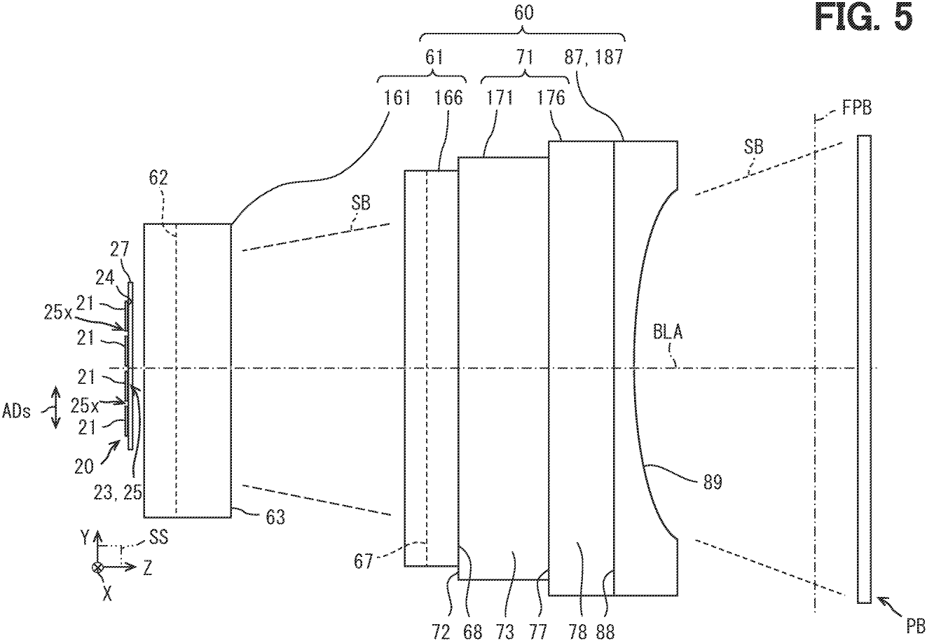

The light-emitting unit 20 has a plurality of VCSEL (Vertical Cavity Surface Emitting Laser) arrays 21 and a cover glass 27 (see FIGS. 4 and 5) that protects each of the plurality of VCSEL arrays 21. The VCSEL array 21 is formed in the shape of a long rectangular plate as a whole. A light-emitting region 22 is formed in a longitudinal shape on one surface of a plate of each of the plurality of VCSEL arrays 21. Each of the plurality of VCSEL arrays 21 is mounted on a main substrate of the light-emitting unit 20 with its posture of facing each of the light-emitting regions 22 substantially in the same direction. Each of the plurality of VCSEL arrays 21 is arranged in one line with a space interposed therebetween. A specific direction along which the plurality of VCSEL arrays 21 are arranged is designated as a light source array direction ADs. Each of the plurality of VCSEL arrays 21 is held on the main substrate with the longitudinal direction of the light-emitting region 22 aligned with the light source array direction ADs. The light-emitting unit 20 is held by a lens barrel of the optical unit 60 or a light-shielding container in such a posture that each of the light-emitting regions 22 faces the optical unit 60 and the scanning unit 30.

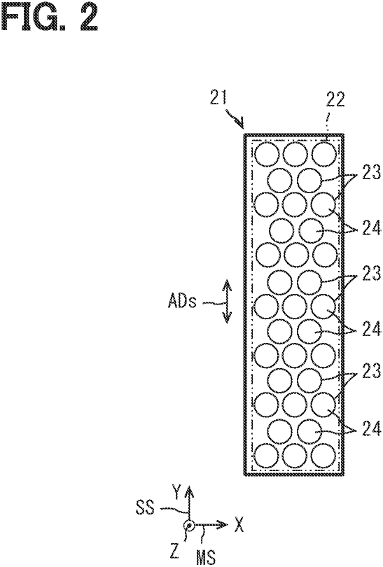

A large number (i.e., plurality) of VCSEL elements 23, which are laser diodes, are formed in the light-emitting region 22 of the VCSEL array 21 (see FIG. 2). The VCSEL element 23 has a resonator for laser oscillation. The resonator includes a P-type semiconductor layer, an N-type semiconductor layer, an active layer provided between these layers, a pair of reflecting mirrors arranged to sandwich the active layer, together with other components. A DBR (Distributed Bragg Reflector) formed by stacking semiconductors or dielectrics is used as the pair of reflecting mirrors. The VCSEL element 23 amplifies the light generated in the active layer by applying a voltage to each of the semiconductor layers by stimulated emission, and generates phase-matched coherent laser light by repeated reflection by the pair of reflecting mirrors. The VCSEL element 23 has a laser-emitting surface 24 formed on its circular top surface, and emits laser light from the laser-emitting surface 24 in a direction orthogonal to a substrate surface of the element.

A large number of VCSEL elements 23 are two-dimensionally arranged in the light-emitting region 22 at intervals from each other. Each of the VCSEL elements 23 is regularly arranged in the light-emitting region 22 with the laser-emitting surface 24 aligned with a normal direction of the light-emitting region 22 (see Z direction in FIG. 2). Each of the VCSEL elements 23 is electrically connected to the controller 50, and emits near-infrared laser light as a beam SB at light emission timing according to an electric signal from the controller 50. An aggregate of a large number of beams SB emitted from each of the VCSEL elements 23 becomes the projected beam PB described above.

In the light-emitting unit 20, a laser oscillation opening 25 having a line shape, i.e., extending along the light source array direction ADs, is formed in a pseudo fashion by the above-described configuration in which the VCSEL array 21 having a large number of VCSEL elements 23 is arranged in a single row. The normal to the center of the laser oscillation opening 25 is an optical axis of the beam SB in the light-emitting unit 20 (hereinafter referred to as a beam light axis BLA). The dimension (i.e., a longitudinal dimension) of the laser oscillation opening 25 along the light source array direction ADs is set to be significantly greater than the dimension (i.e., a width dimension) along the width direction orthogonal to the light source array direction ADs, which may be, for example, 100 times or more of the width dimension. A predetermined gap is reserved between the plurality of VCSEL arrays 21 in order to guarantee cooling performance and manufacturability, for example. As a result, a non-light emitter 25x (see FIG. 1) due to the gap between the arrays inevitably occurs in the laser oscillation opening 25.

The scanning unit 30 projects, as a projected beam PB, the beam SB emitted from each of the VCSEL element 23, for scanning the measurement area. In addition, the scanning unit 30 causes the reflected beam RB reflected by the measurement area to enter the light-receiving unit 40. The scanning unit 30 includes a drive motor 31, a scanning mirror 33, and the like.

The drive motor 31 is, for example, a voice coil motor, a brushed DC motor, a stepping motor, or the like. The drive motor 31 has a shaft portion 32 mechanically coupled to the scanning mirror 33. The shaft portion 32 is arranged along the light source array direction ADs and defines a rotation axis AS of the scanning mirror 33. The rotation axis AS is substantially in parallel with the light source array direction ADs. The drive motor 31 drives the shaft portion 32 at a rotation amount and a rotation speed according to the electric signal from the controller 50.

The scanning mirror 33 reciprocally rotates about the rotation axis AS defined by the shaft portion 32, thereby swinging in a finite angular range RA. The angular range RA of the scanning mirror 33 can be set by a mechanical stopper, an electromagnetic stopper, drive control, or the like. The angular range RA is limited so that the projected beam PB does not leave the optical window of the housing.

The scanning mirror 33 has a body portion 35 and a reflecting surface 36. The body portion 35 is formed in a flat plate shape, for example, made of glass, synthetic resin, or the like. The body portion 35 is coupled to the shaft portion 32 of the drive motor 31 using a mechanical component made of metal or the like. The reflecting surface 36 is a mirror surface obtained by performing vapor deposition of a metal film such as aluminum, silver or gold on one surface of the body portion 35 and further forming a protective film such as silicon dioxide on the vapor-deposited surface. The reflecting surface 36 is formed in a smooth rectangular planar shape. The reflecting surface 36 is provided in a posture in which the longitudinal direction is aligned with the rotation axis AS. As a result, the longitudinal direction of the reflecting surface 36 substantially matches the light source array direction ADs.

The scanning mirror 33 is provided to accommodate both of the projected beam PB and the reflected beam RB. That is, the scanning mirror 33 serves a part of the reflecting surface 36 as a projecting reflector 37 used for projecting the projected beam PB, and serves another part of the reflecting surface 36 as a receiving reflector 38 used for receiving the reflected beam RB. The projecting reflector 37 and the receiving reflector 38 may be defined as areas separated from each other on the reflecting surface 36, or may be defined as areas at least partially overlapping each other.

The scanning mirror 33 changes a deflection direction of the projected beam PB according to the change in the orientation of the reflecting surface 36. The scanning mirror 33 chronologically and spatially scans the measurement area by moving the projected beam PB according to the rotation of the drive motor 31. Scanning by the scanning mirror 33 is scanning only about the rotation axis AS, and is one-dimensional scanning in which scanning in the light source array direction ADs is omitted.

With the configuration described above, a main scanning plane MS of the scanning mirror 33 is a plane that is substantially orthogonal to the rotation axis AS. On the other hand, a plane extending along (i.e., substantially in parallel with) both of (i) the beam light axis BLA of the beam SB entering the scanning unit 30 from the light-emitting unit 20 and (ii) the rotation axis AS is a sub-scanning plane SS of the scanning mirror 33. The main scanning plane MS and the sub-scanning plane SS are planes orthogonal to each other. The light source array direction ADs is a direction substantially in parallel with the sub-scanning plane SS, and is a direction substantially orthogonal to the main scanning plane MS. The scanning by using the scanning mirror 33 is performed as a scan of the irradiation range of the projected beam PB extending in a line shape along the light source array direction ADs, which reciprocates along the main scanning plane MS.

Here, when the LiDAR device 100 is mounted on a vehicle, the light source array direction ADs, the rotation axis AS, and the sub-scanning plane SS are respectively aligned with the vertical direction. On the other hand, the beam light axis BLA and the main scanning plane MS are respectively aligned with the horizontal direction. As described above, the shape of the projected beam PB irradiated to a measurement range becomes a line shape extending in the vertical direction, thereby defining the vertical angle of view of the LiDAR device 100. On the other hand, the finite angular range RA in scanning by the scanning mirror 33 defines the horizontal angle of view of the LiDAR device 100 because it defines the irradiation range of the projected beam PB.

The light-receiving unit 40 receives the reflected beam RB from the measurement area, which is a return light of the projected beam PB projected thereto. The reflected beam RB is a laser light that is incident on the scanning mirror 33 after the projected beam PB that has passed through the optical window of the housing is reflected by the measurement object that exists in the measurement area, passes through the optical window again, and is incident on the scanning mirror 33. Since the speed of the projected beam PB and the reflected beam RB are sufficiently high with respect to the rotation speed of the scanning mirror 33, the phase shift between the projected beam PB and the reflected beam RB is negligible. Therefore, the reflected beam RB is reflected by the reflecting surface 36 at substantially the same angle of reflection as the projected beam PB, and is guided to the light-receiving unit 40 in a direction opposite to that of the projected beam PB.

The light-receiving unit 40 includes a detector 41, a light-receiving lens 44, and the like. The detector 41 is provided with a detection surface 42 and a decoder. The detection surface 42 is formed by a large number of light-receiving elements. The large number of light-receiving elements are arranged to have an array shape in a highly-integrated state, and form a long, rectangular element array on the detection surface 42. The longitudinal direction of the detection surface 42 is aligned with the light source array direction ADs, which is the longitudinal direction of the laser oscillation opening 25, and is substantially in parallel with the light source array direction ADs. With the configuration described above, the detection surface 42 can efficiently receive the reflected beam RB in a line shape that extends along the light source array direction ADs.

As an example of the light-receiving element, a single photon avalanche diode (SPAD) is adopted. When one or more photons are incident on the SPAD, the electron doubling action due to avalanche doubling produces an electric pulse. The SPAD can output an electric pulse, which is a digital signal, without going through an AD conversion circuit, thereby high-speed readout of the detection result of the reflected beam RB condensed on the detection surface 42 is realized. Note that an element different from the SPAD can also be adopted as the light-receiving element. For example, a normal avalanche photodiode, other photodiodes, etc. can be adopted as the light-receiving element.

The decoder is an electric circuit unit that outputs an electric pulse generated by the light-receiving element to the outside. The decoder sequentially selects a target element from which electric pulses are extracted from among a large number of light-receiving elements. The decoder outputs the electric pulse of the selected light-receiving element to the controller 50. When the outputs from all the light-receiving elements are complete, one sampling is complete.

The light-receiving lens 44 is an optical element positioned on an optical path of the reflected beam RB from the scanning mirror 33 toward the detector 41. The light-receiving lens 44 forms a light-receiving optical axis RLA. The light-receiving optical axis RLA is defined as an axis aligned with a virtual ray passing through the center of curvature of each of the refractive surfaces of the light-receiving lens 44. The light-receiving optical axis RLA is substantially in parallel with the beam light axis BLA. The light-receiving lens 44 condenses and focuses the reflected beam RB to the detection surface 42. The light-receiving lens 44 condenses the reflected beam RB reflected by the reflecting surface 36 to the detection surface 42 regardless of the orientation of the scanning mirror 33.

The controller 50 controls the light detection of the measurement area. The controller 50 includes (i) a control circuit section including a processor, a RAM, a storage section, an input/output interface, and a bus connecting them, and (ii) a drive circuit section for driving the VCSEL element 23 and the drive motor 31. The control circuit section is mainly composed of a microcontroller including, for example, a CPU (Central Processing Unit) as a processor. The control circuit section may be configured mainly as an FPGA (Field-Programmable Gate Array), an ASIC (Application Specific Integrated Circuit) or the like.

The controller 50 is electrically connected to each of the VCSEL elements 23, the drive motor 31 and the detector 41. The controller 50 includes functional units such as a light emission control unit 51, a scanning control unit 52, a measurement calculation unit 53, and the like. Each of the functional units may be constructed as a software component based on a program, or may be constructed as a hardware component.

The light emission control unit 51 outputs a drive signal to each of the VCSEL elements 23 so that the beam SB is emitted from each of the VCSEL elements 23 at the light emission timing coordinated with the beam scanning by the scanning mirror 33. The light emission control unit 51 oscillates the beam SB from each of the VCSEL elements 23 in the form of a short pulse. The light emission control unit 51 may control the plurality of VCSEL elements 23 (a) to oscillate substantially simultaneously, or (b) to oscillate sequentially, i.e., one by one, with a slight time difference, for emitting the beams SB therefrom.

The scanning control unit 52 outputs a drive signal to the drive motor 31 to realize beam scanning in cooperation with beam oscillation by the VCSEL elements 23.

The measurement calculation unit 53 performs calculation processing on the electric pulse input from the detector 41, and determines the presence or absence of the measurement object in the measurement area. In addition, the measurement calculation unit 53 measures the distance to the measurement object whose existence is grasped. In each sampling, the measurement calculation unit 53 counts the number of electric pulses output from each of the light-receiving elements of the detector 41 after the projected beam PB is projected. The measurement calculation unit 53 generates a histogram recording the number of electric pulses for each sampling. The class of the histogram indicates a time of flight (TOF) of light from an emission time of the beam SB to a detection time of the reflected beam RB. The sampling frequency of the detector 41 corresponds to the time resolution in TOF measurement.

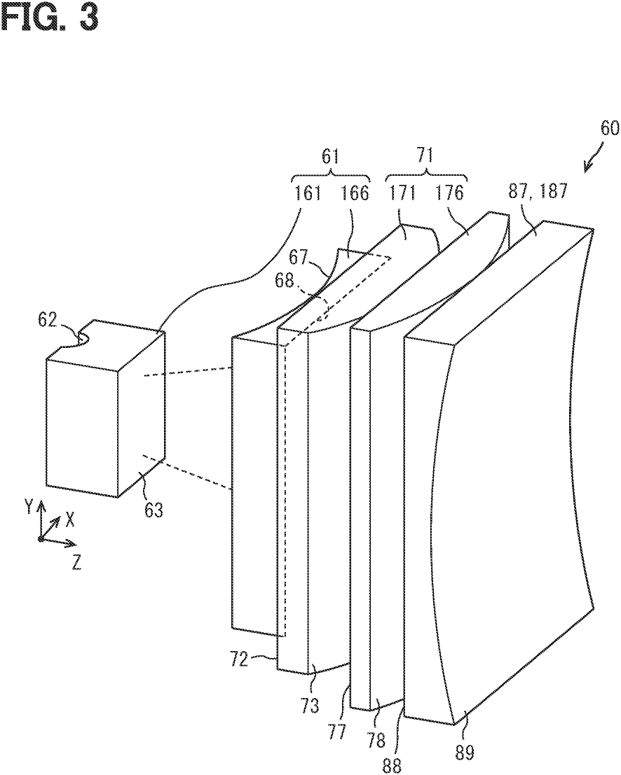

The optical unit 60 includes a group of optical elements positioned on the optical path of the beam SB from the light-emitting unit 20 to the scanning unit 30. The optical unit 60 adjusts the shape of a group of beams SB emitted from each of the VCSEL elements 23, and makes the shaped group of beams SB incident on the reflecting surface 36. The optical unit 60 includes a plurality (e.g., two) of first optical elements 61, a plurality (e.g., two) of second optical elements 71, a beam shaping lens 87, and the like (see FIG. 3). The first optical element 61, the second optical element 71, and the beam shaping lens 87 are made of translucent material having excellent optical properties, such as synthetic quartz glass, synthetic resin or the like. The first optical element 61, the second optical element 71, and the beam shaping lens 87 are housed in a lens barrel, and a relative positional relationship among them is strictly defined.

Here, in order to describe the detailed configuration of the optical unit 60, the X-axis, Y-axis and Z-axis are defined. The X-axis is substantially orthogonal to the sub-scanning plane SS of the scanning unit 30, and is substantially in parallel with the main scanning plane MS of the scanning unit 30. The X-axis corresponds to the fast axis of laser light. The Y-axis is substantially in parallel with the light source array direction ADs and the rotation axis AS. The Y-axis corresponds to the slow axis of laser light. The Z-axis is substantially in parallel with the beam light axis BLA that extends from the laser oscillation opening 25 to the scanning mirror 33. The Z direction is the transmission direction of the beam SB that passes through the optical unit 60, and is a direction from the light-emitting unit 20 to the scanning unit 30 along the Z axis. As described above, a Z-X plane of the optical unit 60 coincides with the main scanning plane MS of the scanning unit 30 (see FIG. 4). Also, a Y-Z plane of the optical unit 60 coincides with the sub-scanning plane SS of the scanning unit 30 (see FIG. 5).

The first optical element 61 is an optical element having a negative power along the transmission direction (i.e., Z direction) of the beam SB on the main scanning plane MS orthogonal to the light source array direction ADs. In the first embodiment, a first concave cylindrical lens 161 and a second concave cylindrical lens 166 are provided as the first optical element 61 before the two second optical elements 71, respectively.

The first concave cylindrical lens 161 has a cylindrical incident surface 62 and a planar emission surface 63. The cylindrical incident surface 62 is a lens surface formed in a semi-cylindrical shape and concavely curved toward the incident side. The cylindrical incident surface 62 is arranged to face the laser oscillation opening 25 of the light-emitting unit 20, in a posture of aligning the axial direction (i.e., generatrix, or generating line) with the light source array direction ADs (i.e., Y-axis), or in other words, in a posture of aligning a power direction (i.e., a direction orthogonal to the generatrix) with the X-axis. The cylindrical incident surface 62 has a curvature only on the main scanning plane MS. The planar emission surface 63 is a smooth planar lens surface, and is substantially orthogonal to the beam light axis BLA.

The second concave cylindrical lens 166 has a cylindrical incident surface 67 and a planar emission surface 68. The cylindrical incident surface 67 is a lens surface formed in a partially cylindrical surface shape, and is concavely curved toward the incident side. The curvature of the cylindrical incident surface 67 is made smaller than the curvature of the cylindrical incident surface 62. The cylindrical incident surface 67 is arranged behind the first concave cylindrical lens 161 to face the planar emission surface 63. The cylindrical incident surface 67 is arranged in a posture in which the axial direction (i.e., generatrix) is aligned with the light source array direction ADs (i.e., Y-axis), or in other words, in a posture in which the power direction (i.e., a direction orthogonal to the generatrix) is aligned with the X-axis. Like the cylindrical incident surface 62, the cylindrical incident surface 67 also has a curvature only on the main scanning plane MS. The planar emission surface 68 is a smooth planar lens surface that is substantially orthogonal to the beam light axis BLA.

Each of the concave cylindrical lenses 161 and 166 is arranged on the optical path of the beam SB so that the beam light axis BLA passes through the optical centers of the cylindrical incident surfaces 62 and 67 and the planar emission surfaces 63 and 68, respectively. The normals of the respective optical centers of the cylindrical incident surfaces 62, 67 and the planar emission surfaces 63, 68, that is, the lens optical axes of the concave cylindrical lenses 161, 166 substantially coincide with the beam light axis BLA. The concave cylindrical lenses 161 and 166 are arranged apart from each other in the transmission direction of the beam SB. Therefore, the cylindrical incident surface 67 is not in contact with the planar emission surface 63 and is positioned away from the planar emission surface 63.

Each of the concave cylindrical lenses 161, 166 spreads the beam SB substantially only on the main scanning plane MS by the refraction action on the beam SB by the cylindrical incident surfaces 62, 67 and the planar emission surfaces 63, 68 (see FIG. 4). The beam SB is deflected progressively into the directions away from the beam light axis BLA by the respective lens surfaces of the first concave cylindrical lens 161 and the second concave cylindrical lens 166. On the other hand, the concave cylindrical lenses 161 and 166 do not substantially exhibit the optical action of spreading the beam SB on the sub-scanning plane SS.

The second optical element 71 is an optical element having a positive power along the transmission direction (i.e., Z direction) of the beam SB on the main scanning plane MS. The positive power of the second optical element 71 is made greater than the negative power of the first optical element 61 so that the combined power of the first optical element 61 and the second optical element 71 is positive. In the first embodiment, a first convex cylindrical lens 171 and a second convex cylindrical lens 176 are respectively provided as the second optical elements 71 behind the two first optical elements 61.

The first convex cylindrical lens 171 has a planar incident surface 72 and a cylindrical emission surface 73. The planar incident surface 72 is a smooth, planar lens surface, and is disposed behind the second concave cylindrical lens 166 to face the planar emission surface 68. The planar incident surface 72 is in contact with the planar emission surface 68. The planar incident surface 72 may be bonded to the planar emission surface 68 by UV curable glue or the like. The cylindrical emission surface 73 is a lens surface formed in a partially cylindrical shape, and is convexly curved toward the emission side. The cylindrical emission surface 73 is arranged to face the second convex cylindrical lens 176, in a posture in which the axial direction is aligned with the light source array direction ADs (i.e., Y-axis), or in other words, in a posture in which the power direction (i.e., a direction orthogonal to the generatrix) is aligned with the X-axis. The cylindrical emission surface 73 has a curvature only on the main scanning plane MS.

The second convex cylindrical lens 176 has a planar incident surface 77 and a cylindrical emission surface 78. The planar incident surface 77 is a smooth and planar lens surface, and is arranged behind the first convex cylindrical lens 171 to face the cylindrical emission surface 73. The planar incident surface 77 is in contact with the cylindrical emission surface 73. The cylindrical emission surface 78 is a lens surface formed in a partially cylindrical shape, and is convexly curved toward the emission side. The curvature of the cylindrical emission surface 78 is made greater than the curvature of the cylindrical emission surface 73. The cylindrical emission surface 78 is arranged to face the beam shaping lens 87, in a posture in which the axial direction (i.e., generatrix) is aligned with the light source array direction ADs (i.e., Y-axis), or in other words, in a posture in which the power direction (i.e., orthogonal to the generatrix) is aligned with the X-axis. The cylindrical emission surface 78 has curvature only on the main scanning plane MS.

Each of the convex cylindrical lenses 171 and 176 described above is arranged on the optical path of the beam SB so that the beam light axis BLA passes through the optical centers of the planar incident surfaces 72 and 77 and the cylindrical emission surfaces 73 and 78, respectively. The normals at the respective optical centers of the planar incident surfaces 72, 77 and the cylindrical emission surfaces 73, 78, that is, the lens optical axes of the convex cylindrical lenses 171, 176 substantially coincide with the beam light axis BLA.

Each of the convex cylindrical lenses 171, 176 condenses the beam SB substantially only on the main scanning plane MS due to the refraction action on the beam SB by the planar incident surfaces 72, 77 and the cylindrical emission surfaces 73, 78 (see FIG. 4). The beam SB is deflected progressively toward the beam light axis BLA by the lens surfaces of the first convex cylindrical lens 171 and the second convex cylindrical lens 176. On the other hand, the convex cylindrical lenses 171 and 176 do not substantially exhibit the optical action of condensing the beam SB on the sub-scanning plane SS.

The beam shaping lens 87 is positioned behind the second optical element 71. The beam shaping lens 87 has a negative power along the transmission direction (i.e., Z direction) on the sub-scanning plane SS. A plano-concave cylindrical lens 187 is employed as the beam shaping lens 87.

The plano-concave cylindrical lens 187 is an optical element having an astigmatic optical action. The plano-concave cylindrical lens 187 has a planar incident surface 88 and a cylindrical emission surface 89. The planar incident surface 88 has a smooth and planar shape, and is substantially orthogonal to the beam light axis BLA. The planar incident surface 88 is arranged behind the second convex cylindrical lens 176 to face the cylindrical emission surface 78. The planar incident surface 88 is in contact with the cylindrical emission surface 78. The cylindrical emission surface 89 is a lens surface formed in a partially cylindrical shape. The cylindrical emission surface 89 is arranged in a posture in which the axial direction (i.e., generatrix) is aligned with the X-axis, or in other words, in a posture in which the power direction (i.e., a direction orthogonal to the generatrix) is aligned with the Y-axis. The cylindrical emission surface 89 has a shape concavely curved in the Z direction, which is the emission side (see FIGS. 3 and 5).

The plano-concave cylindrical lens 187 is arranged in such a posture that the lens cross section having a negative power is in parallel with the sub-scanning plane SS. The plano-concave cylindrical lens 187 is arranged on the optical path of the beam SB so that the beam light axis BLA passes through the respective optical centers of the planar incident surface 88 and the cylindrical emission surface 89. The plano-concave cylindrical lens 187 spreads the beam SB along the light source array direction ADs on the sub-scanning plane SS with the refraction action on the beam SB by the planar incident surface 88 and the cylindrical emission surface 89 (see FIG. 5). On the other hand, the plano-concave cylindrical lens 187 does not substantially exhibit the optical action of deflecting the beam SB on the main scanning plane MS (see FIG. 4).

Details of the optical action by a group of the optical elements in the optical unit 60 are further described.

On the sub-scanning plane SS (i.e., Y-Z plane, see FIG. 5), a composite focal plane FPB by the group of the optical elements in the optical unit 60 is defined behind the beam shaping lens 87. Since the first optical element 61 and the second optical element 71 are cylindrical lenses having no power on the sub-scanning plane SS, the position of the composite focal plane FPB is determined mainly by the curvature of the cylindrical emission surface 89. Due to the negative power of the cylindrical emission surface 89, the beam SB passing through the optical unit 60 is spread along the light source array direction ADs as described above. Therefore, even if there are non-light emitters 25x between the VCSEL arrays 21, the beams SB transmitted through the optical unit 60 overlap with each other behind the composite focal plane FPB, to form the projected beam PB having a continuous linear shape.

On the other hand, on the main scanning plane MS (i.e., Z-X plane, see FIG. 4), the composite focal plane FPF by the group of the optical elements in the optical unit 60 is defined before the first concave cylindrical lens 161. Since the beam shaping lens 87 has no power on the main scanning plane MS, the position of the composite focal plane FPF is determined by the curvatures of the respective cylindrical surfaces of the first optical element 61 and the second optical element 71. Each of the plurality of VCSEL arrays 21 is arranged at a position that intersects with the composite focal plane FPF. As a result, the first optical element 61 and the second optical element 71 function as collimators, and the beam SB emitted from the VCSEL array 21 is magnified by a predetermined magnification and is then emitted from the optical unit 60 as a parallel light along the beam light axis BLA. As described above, the optical unit 60 can suppress the spread of the line width of the linear beam SB and can form the projected beam PB in a line shape capable of maintaining a predetermined beam width.

In the first embodiment described so far, the first optical element 61 having a negative power is arranged before the second optical element 71 having a positive power on the main scanning plane MS orthogonal to the light source array direction ADs. Therefore, the principal plane formed by the combination of the first optical element 61 and the second optical element 71 is defined behind the second optical element 71 on the main scanning plane MS. Due to the configuration described above, an arrangement in which the light-emitting unit 20 is brought closer to the optical unit 60 is realized while reserving the distance from the composite focal plane FPF to the principal plane on the main scanning plane MS, that is, the focal length of the optical unit 60. As a result, it is possible to suppress the increase of volume / size of the optical system including the light-emitting unit 20 and the optical unit 60 while suppressing the increase of the width of the projected beam PB in a line shape that extends along the light source array direction ADs. When increase of the width of the projected beam PB is suppressed, speckle noise generated in the projected beam PB is reducible.

In addition, in the first embodiment, multiple first optical elements 61 and multiple second optical elements 71 are provided. Further, the plurality of first optical elements 61 are positioned before the plurality of second optical elements 71. As described above, according to the optical configuration in which a plurality of optical elements are combined, the refraction caused by each of the lens surfaces is reducible. As a result, since the aberration due to refraction is reducible, it is possible to form the projected beam PB in a clear line shape.

Further, in the first embodiment, the planar emission surface 68 of the second concave cylindrical lens 166 provided as the first optical element 61 is in contact with the planar incident surface 72 of the first convex cylindrical lens 171 provided as the second optical element 71. According to such an in-contact configuration, it is possible to reduce the tolerance that occurs between the first optical element 61 and the second optical element 71, and it is also possible to reduce variations of the position of the composite focal plane FPF. According to the above, since the VCSEL elements 23 can be arranged accurately on the composite focal plane FPF, it is possible to stably form the projected beam PB in a clear line shape.

Further, the optical unit 60 of the first embodiment includes, as the first optical element 61, the concave cylindrical lenses 161 and 166 having the cylindrical incident surfaces 62 and 67 concavely curved toward the incident side. In addition, the optical unit 60 includes, as the second optical element 71, the convex cylindrical lenses 171, 176 having the cylindrical emission surfaces 73, 78 convexly curved toward the emission side. As described above, by using a highly manufacturable cylindrical element as the optical element, it is possible to easily provide the optical unit 60, and at the same time, it is possible to reliably obtain the effect of suppressing the spread of the projected beam PB on the main scanning plane MS.

In addition, the light-emitting unit 20 of the first embodiment includes the VCSEL array 21 in which the VCSEL elements 23 with the laser-emitting surface 24 directed in the transmission direction are two-dimensionally arranged in the longitudinal-shaped light-emitting region 22 whose longitudinal direction is the light source array direction ADs. By adopting such a VCSEL array 21, a large number of VCSEL elements 23 can be arranged in the light-emitting unit 20 at high density, thereby enabling a high power output of the projected beam PB.

Further, even if the width of the laser oscillation opening 25 in the short direction is widened by the two-dimensional arrangement of the VCSEL elements 23, the optical action of the optical unit 60 can suppress the increase of the width of the projected beam PB. According to the above, the configuration in which the above-described optical unit 60 is combined with the VCSEL array 21 can provide a high output of the projected beam PB while avoiding an increase in speckle noise caused by laser interference. Therefore, an improvement in detection capability of the LiDAR device 100 is realized.

Further, the scanning unit 30 of the first embodiment also has the scanning mirror 33 that rotates about the rotation axis AS aligned with the light source array direction ADs. As described above, if the light source array direction ADs and the rotation axis AS are substantially parallel, the LiDAR device 100 operates by scanning with the line-shaped projected beam PB in a reciprocating movement along the width direction, in which the spread of the beam PB in the width direction is suppressed. As described above, when the projected beam PB is sharply shaped, the detection accuracy of the LiDAR device 100 is improvable.

In the first embodiment, the VCSEL array 21 corresponds to a “light-emitting element array,” the VCSEL element 23 corresponds to a “light emitter” and a “surface-emitting laser element,” the laser-emitting surface 24 corresponds to an “emitting surface,” and the scanning mirror 33 corresponds to a “rotary mirror.” Further, the cylindrical incident surfaces 62 and 67 correspond to a “concave incident surface,” the planar emission surface 68 corresponds to a “front emission surface,” the planar incident surface 72 corresponds to a “rear incident surface,” and the cylindrical emission surfaces 73, 78 correspond to a “convex emission surface.” Further, the first concave cylindrical lens 161 and the second concave cylindrical lens 166 correspond to a “concave cylindrical lens,” and the first convex cylindrical lens 171 and the second convex cylindrical lens 176 correspond to a “convex cylindrical lens”. Further, the light source array direction ADs corresponds to a “specific array direction,” the main scanning plane MS corresponds to a “specific section,” the sub-scanning plane SS corresponds to an “orthogonal section,” and the Z direction corresponds to “(the beam SB’s) transmission direction.” Further, the reflected beam RB corresponds to a “return light,” and the LiDAR device 100 corresponds to a “light detection device.”

### Second Embodiment

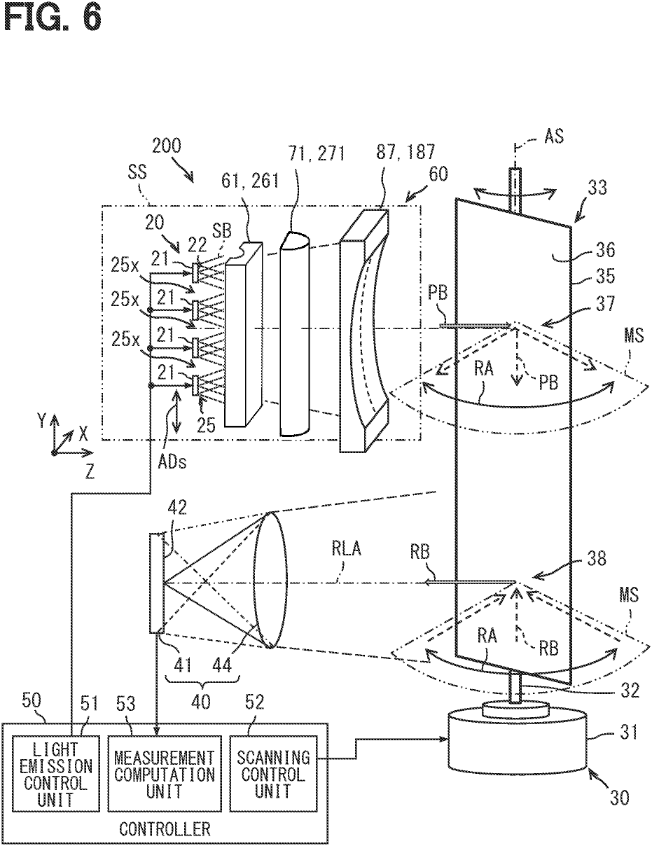

The second embodiment of the present disclosure, shown in FIGS. 6-8, is a modification of the first embodiment. One first optical element 61 and one second optical element 71 are provided in the optical unit 60 of the second embodiment. Specifically, the optical unit 60 of the second embodiment is provided with a concave cylindrical lens 261 and a convex cylindrical lens 271 as the first optical element 61 and the second optical element 71.

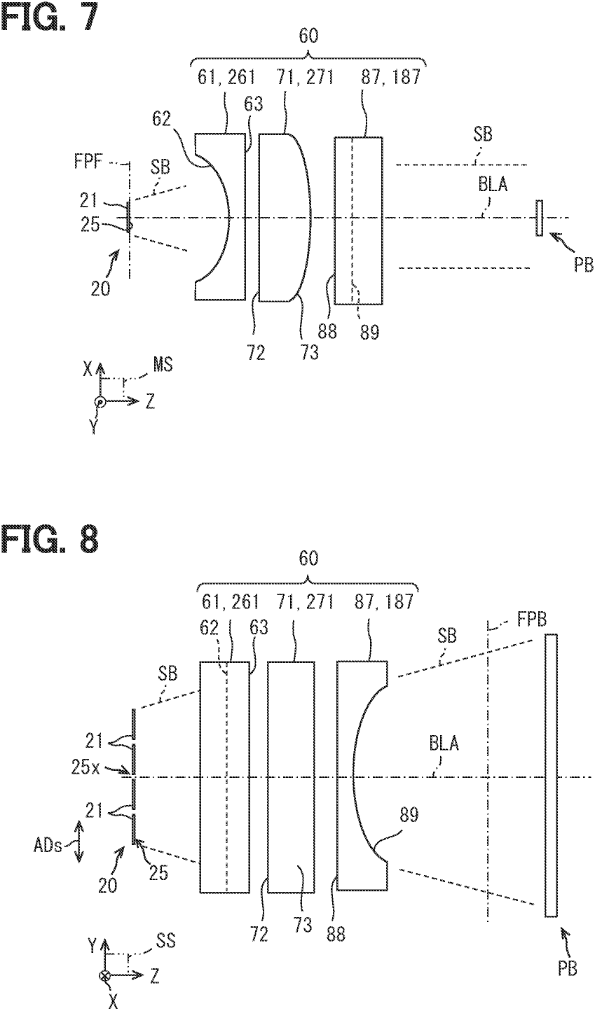

The concave cylindrical lens 261 has a configuration corresponding to the first concave cylindrical lens 161 (see FIG. 1) of the first embodiment, and has the cylindrical incident surface 62 and the planar emission surface 63. The cylindrical incident surface 62 is a partially cylindrical lens surface concavely curved toward the incident side. The cylindrical incident surface 62 is arranged to face the laser oscillation opening 25. The planar emission surface 63 is a smooth planar lens surface, and is arranged to face the convex cylindrical lens 271. The concave cylindrical lens 261 spreads the beam SB substantially only on the main scanning plane MS due to the refraction of the beam SB by the cylindrical incident surface 62 and the planar em ission surface 63 (see FIG. 7). On the other hand, the concave cylindrical lens 261 does not substantially exhibit the optical action of spreading the beam SB on the sub-scanning plane SS.

The convex cylindrical lens 271 has a configuration corresponding to the first convex cylindrical lens 171 (see FIG. 1) of the first embodiment, and has the planar incident surface 72 and the cylindrical emission surface 73. The planar incident surface 72 is a smooth planar lens surface, and is arranged to face the planar emission surface 63 with a gap interposed therebetween. The planar incident surface 72 is not in contact with the planar emission surface 63, and is positioned away from the planar emission surface 63. The cylindrical emission surface 73 is a partially cylindrical lens surface that is convexly curved toward the emission side. The cylindrical emission surface 73 is arranged to face the planar incident surface 88 of the plano-concave cylindrical lens 187. The convex cylindrical lens 271 condenses the beam SB substantially only on the main scanning plane MS due to the refraction of the beam SB by the planar incident surface 72 and the cylindrical emission surface 73 (see FIG. 7). On the other hand, the convex cylindrical lens 271 does not substantially exhibit the optical action of condensing the beam SB on the sub-scanning plane SS.

In the LiDAR device 200 of the second embodiment described so far, the same effect as in the first embodiment is achievable, and the light-emitting unit 20 is arranged closer to the optical unit 60 while reserving the focal length of the optical unit 60. Therefore, it is possible to suppress the increase of the volume / size of the optical system while suppressing the increase of the width of the line-shaped projected beam PB extending along the light source array direction ADs.

Additionally, in the second embodiment, the planar emission surface 63 of the first optical element 61 is separated from the planar incident surface 72 of the second optical element 71. With such a lens arrangement, the position of the principal plane on the main scanning plane MS can be moved away toward the rear side of the second optical element 71. As a result, further volume reduction can be realized while reserving the focal length on the main scanning plane MS. In the second embodiment, the planar emission surface 63 corresponds to a “front emission surface,” the planar incident surface 72 corresponds to a “rear incident surface,” and the LiDAR device 200 corresponds to a “light detection device.”

### Third Embodiment

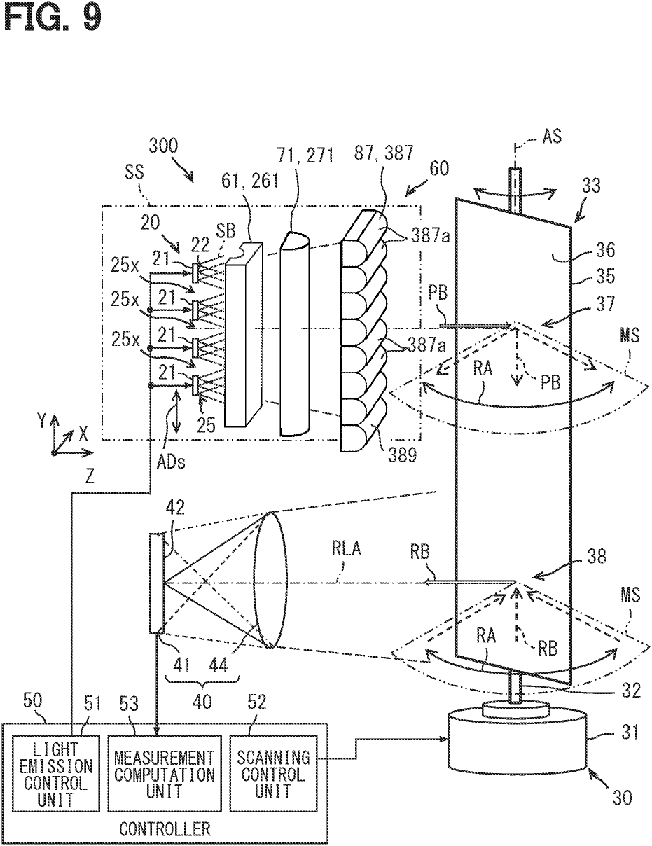

The third embodiment of the present disclosure, shown in FIGS. 9 to 11, is a modification of the second embodiment. A lenticular lens 387 is employed as the beam shaping lens 87 in the optical unit 60 of the third embodiment. The lenticular lens 387 is made of translucent material such as synthetic quartz glass, resin or the like. The lenticular lens 387 includes a large number of micro plano-convex lens portions 387a. The lenticular lens 387 is an optical element in which a large number of plano-convex lens portions 387a are continuously arranged.

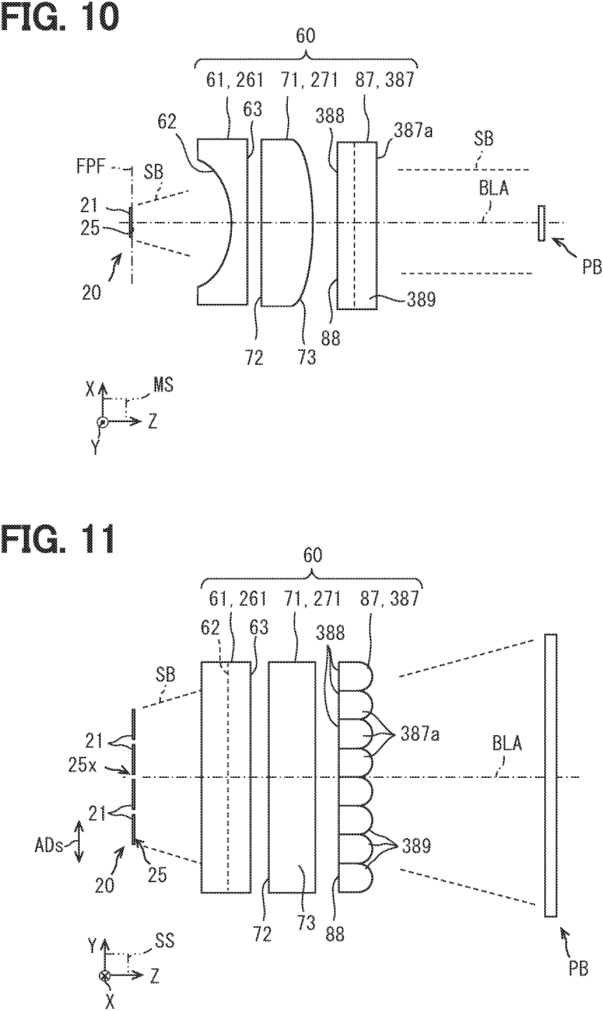

Each of the plano-convex lens portions 387a extends linearly along the X-axis (see FIG. 10). Each of the plano-convex lens portions 387a is arranged continuously along the light source array direction ADs (i.e., Y-axis) (see FIG. 11). Each of the plano-convex lens portions 387a has a micro incident surface 388 and a micro emission surface 389, respectively. The micro incident surface 388 is formed in a smooth plane. Each of the micro incident surfaces 388 of the plurality of plano-convex lens portions 387a are arranged continuously without steps in the light source array direction ADs, and forms the planar incident surface 88 of the lenticular lens 387. The lenticular lens 387 is arranged in a posture in which the planar incident surface 88 is arranged to be orthogonal to the beam light axis BLA. The micro emission surface 389 is formed in a partially cylindrical shape, and has a convexly curved shape in the Z direction, which is the emission side, on the sub-scanning plane SS. A plurality of the micro emission surfaces 389 form the emission surface of the lenticular lens 387 by continuously arranged along the light source array direction ADs.

The lenticular lens 387 has a positive power on the sub-scanning plane SS. The lenticular lens 387 forms a projected beam PB having a continuous line shape (see FIG. 11) by spreading the beam SB substantially only in one direction on the sub-scanning plane SS by the optical action of the micro incident surfaces 388 and the micro emission surfaces 389 for refracting the beam SB. On the other hand, the lenticular lens 387 does not substantially exhibit the optical action of spreading the beam SB on the main scanning plane MS (see FIG. 11).

The LiDAR device 300 of the third embodiment described so far also has the same effect as the second embodiment, i.e., suppresses the increase of the volume / size of the optical system while suppressing the increase of the width of the line-shaped projected beam PB. In addition, in the third embodiment in which the lenticular lens 387 is employed as the beam shaping lens 87, mis-alignment of the lens optical axis along an X-Y plane direction becomes more tolerable as compared with the configuration in which the plano-concave cylindrical lens 187 (see FIG. 6) is used. Incidentally, in the third embodiment, the LiDAR device 300 corresponds to a “light detection device.”

### Fourth Embodiment

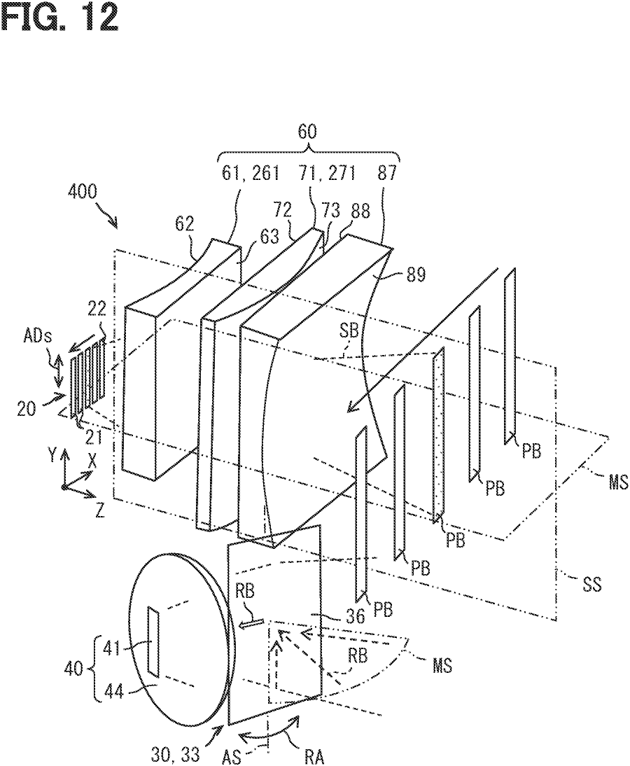

The fourth embodiment of the present disclosure, shown in FIG. 12, is another modification of the second embodiment. In a LiDAR device 400 of the fourth embodiment, the configurations of the light-emitting unit 20 and the scanning unit 30 are different from those of the second embodiment.

The light-emitting unit 20 has multiple VCSEL arrays 21. The multiple VCSEL arrays 21 are arranged along the X-axis, which is the short direction of the light-emitting region 22. Each of the multiple VCSEL arrays 21 is held on the main substrate of the light-emitting unit 20 with a gap from each other reserved in the short direction. Each of the multiple VCSEL arrays 21 is arranged in a posture in which the light-emitting region 22 is oriented in the Z direction and the longitudinal direction of the light-emitting region 22 is aligned with the light source array direction ADs. The multiple VCSEL arrays 21 respectively emit the beam SB in sequence, i.e., in an order of arrangement along the short direction, based on the light emission timing control by a light emission control unit 51 (see FIG. 1). The light emission control unit 51 may switch the light-emitting VCSEL arrays 21 emitting the beam SB sequentially to provide a one-directional movement along the short direction, or may switch the VCSEL arrays 21 emitting the beam SB reciprocally to provide a two-directional movement along the short direction, i.e., back and forth along the X direction.

The group of beams SB emitted from each of the VCSEL arrays 21 form one projected beam PB, which are projected to the measurement area without being reflected by the reflecting surface 36 of the scanning mirror 33. The projected beam PB, which are made up from the group of beams SB emitted from respectively different VCSEL arrays 21, are projected to different positions of the measurement area.

The scanning unit 30 uses the scanning mirror 33 to reflect only the reflected beam RB among the projected beam PB and the reflected beam RB. The direction of the scanning mirror 33 in the scanning unit 30 is synchronously controlled with the switching of the light emission of the VCSEL array 21 by the scanning control unit 52 (see FIG. 1). The scanning unit 30 changes the orientation of the reflecting surface 36 by rotating the scanning mirror 33 about the rotation axis AS, and appropriately causes the reflected beam RB returning from the different positions of the measurement area to enter the detector 41.

The LiDAR device 400 of the fourth embodiment described so far also has the same effect as the second embodiment, i.e., while suppressing the increase of the width of each of the projected beams PB in a line shape by using the concave cylindrical lens 261 and the convex cylindrical lens 271, it is possible to suppress the increase in the volume / size of the optical system.

In addition, if the projected beam PB is electronically scanned by sequentially turning on multiple VCSEL arrays 21 as in the fourth embodiment, the size of the scanning unit 30 is reducible, thereby further reducing the volume / size of the LiDAR device 400. In addition, even in such a form, the spread of the line width of each of the projected beams PB respectively emitted from the multiple VCSEL arrays 21 can be suppressed. Therefore, the optical unit 60 including the concave cylindrical lens 261 and the convex cylindrical lens 271 can exhibit a speckle reduction effect even in a flash type configuration in which the scanning mirror 33 is not used for the scanning movement of the projected beam PB. Incidentally, in the fourth embodiment, the LiDAR device 400 corresponds to a “light detection device.”

### Fifth Embodiment

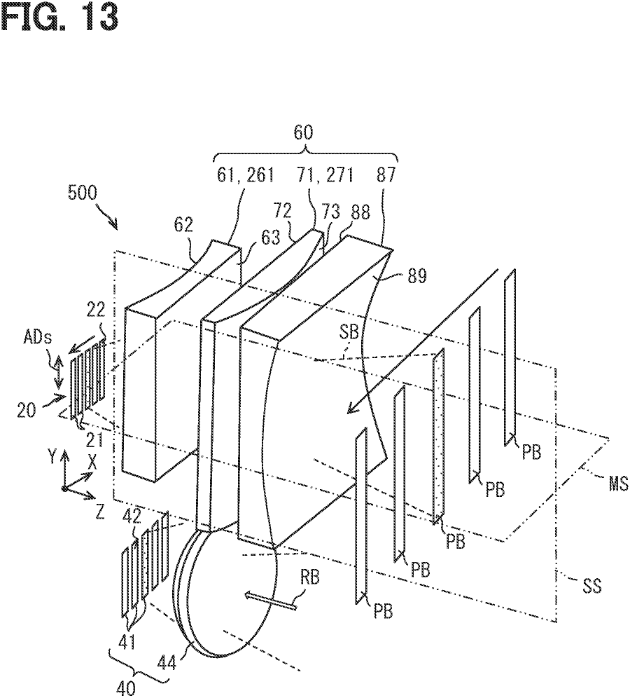

The fifth embodiment of the present disclosure, shown in FIG. 13, is a modification of the fourth embodiment. In a LiDAR device 500 of the fifth embodiment, the configuration corresponding to the scanning unit 30 (see FIG. 12) is omitted. On the other hand, the light-receiving unit 40 is provided with a plurality of detectors 41. The plurality of detectors 41 are arranged along the short direction of the detection surface 42 having a long rectangular shape. Each of the detectors 41 performs detection in synchronization with an electronic scanning of the VCSEL arrays 21 under the detection control of the measurement calculation unit 53 (see FIG. 1). That is, from among the plurality of detectors 41, one detector 41 associated with the VCSEL array 21 emitting the beam SB detects the reflected beam RB.

The LiDAR device 500 of the fifth embodiment described so far has the same effect as the fourth embodiment, i.e., while suppressing the increase of the width of each of the projected beams PB in a line shape by using the concave cylindrical lens 261 and the convex cylindrical lens 271, making it possible to suppress the increase in the volume / size of the optical system. In addition, since the scanning unit 30 is omissible in the fifth embodiment, it is possible to further suppress the volume / size increase of the LiDAR device 500. Incidentally, in the fifth embodiment, the LiDAR device 500 corresponds to a “light detection device.”

### Sixth Embodiment

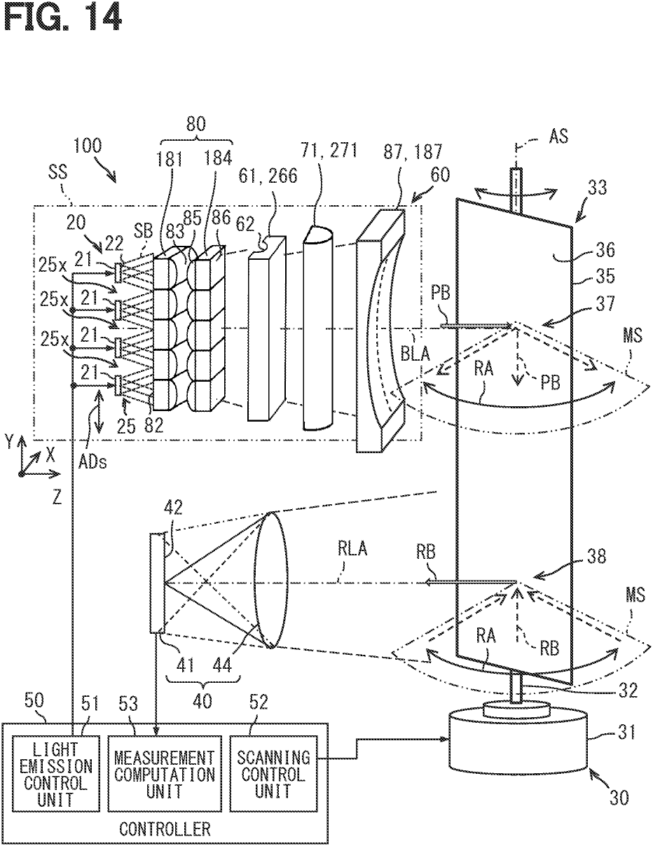

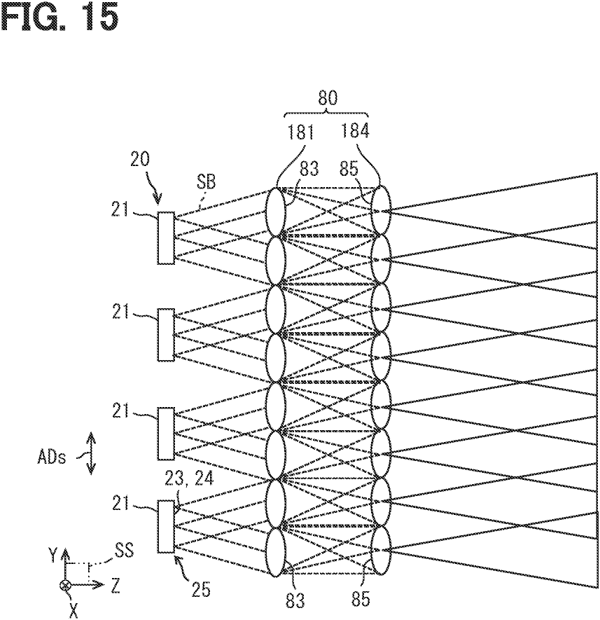

The sixth embodiment of the present disclosure, shown in FIGS. 14 and 15, is yet another modification of the second embodiment. The optical unit 60 of the sixth embodiment includes a homogenizer 80 in addition to the first optical element 61, the second optical element 71 and the beam shaping lens 87.

The homogenizer 80 is put at a position between the light-emitting unit 20 and the first optical element 61. The homogenizer 80 equalizes an intensity of the beam SB among the group of beams SB along the light source array direction ADs. The homogenizer 80 is composed of a first lenticular lens 181, a second lenticular lens 184, and the like. The first lenticular lens 181 and the second lenticular lens 184 have substantially the same configuration, and are optical elements formed by continuously arranging a large number of plano-convex lens portions.

The first lenticular lens 181 is arranged before the second lenticular lens 184 in the optical unit 60. The first lenticular lens 181 has a smooth planar incident surface 82 and an emission surface on which a plurality of emission surface portions 83 are continuously formed along the light source array direction ADs. The incident surface 82 is arranged to face the light-emitting regions 22 of the multiple VCSEL arrays 21. Each of the emission surface portions 83 has a cylindrical shape convexly curved toward the emission side on the sub-scanning plane SS.

The second lenticular lens 184 is arranged behind the first lenticular lens 181 in the optical unit 60. The second lenticular lens 184 has an incident surface in which a plurality of incident surface portions 85 are continuously formed along the light source array direction ADs, and a smooth planar emission surface 86. Each of the incident surface portions 85 has a cylindrical shape convexly curved toward the incident side on the sub-scanning plane SS. Each of the incident surface portions 85 is arranged to face each of the emission surface portions 83 substantially coaxially. A predetermined gap is reserved between each of the incident surface portions 85 and each of the emission surface portions 83. The emission surface 86 is arranged to face the cylindrical incident surface 62 of the first concave cylindrical lens 161 provided as the first optical element 61.

In the LiDAR device 600 of the sixth embodiment described so far, the same effect as in the second embodiment is achievable, i.e., while suppressing the increase of the width of each of the projected beams PB having a line shape by including the first optical element 61 and the second optical element 71 in the optical unit 60, it is possible to suppress the increase in the volume / size of the optical system.

In addition, in the sixth embodiment, facing arrangement of each of the emission surface portions 83 and each of the incident surface portions 85 exhibits the effect of leveling or homogenizing the intensity of the group of beams SB emitted from the multiple VCSEL arrays 21 extending along the light source array direction ADs. By providing the homogenizer 80 having such an effect, the intensity of the projected beam PB in a line shape is less likely to decrease even in the vicinity of both end portions. As a result, it is possible to improve the detection capability over the entire measurement area.

In the sixth embodiment, the first lenticular lens 181 corresponds to a “front optical element,” the second lenticular lens 184 corresponds to a “rear optical element,” and the LiDAR device 600 corresponds to a “light detection device.”

### Other Embodiments

Although a plurality of embodiments of the present disclosure have been described above, the present disclosure should not be construed as being limited to the above embodiments, and can be applied to various embodiments and combinations without departing from the gist of the present disclosure.

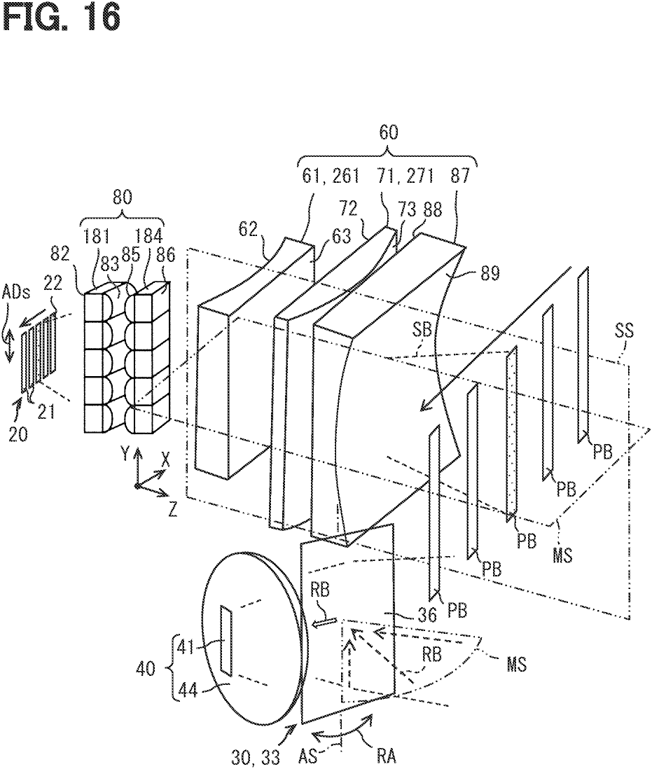

In Modification 1 of the above embodiment shown in FIG. 16, the homogenizer 80 that is substantially the same as the one in the sixth embodiment is combined with the light-emitting unit 20 in which multiple VCSEL arrays 21 are arranged along the short direction. The homogenizer 80 can exhibit the function of equalizing the intensity along the light source array direction ADs for each of the beams SB emitted respectively from the multiple VCSEL arrays 21.

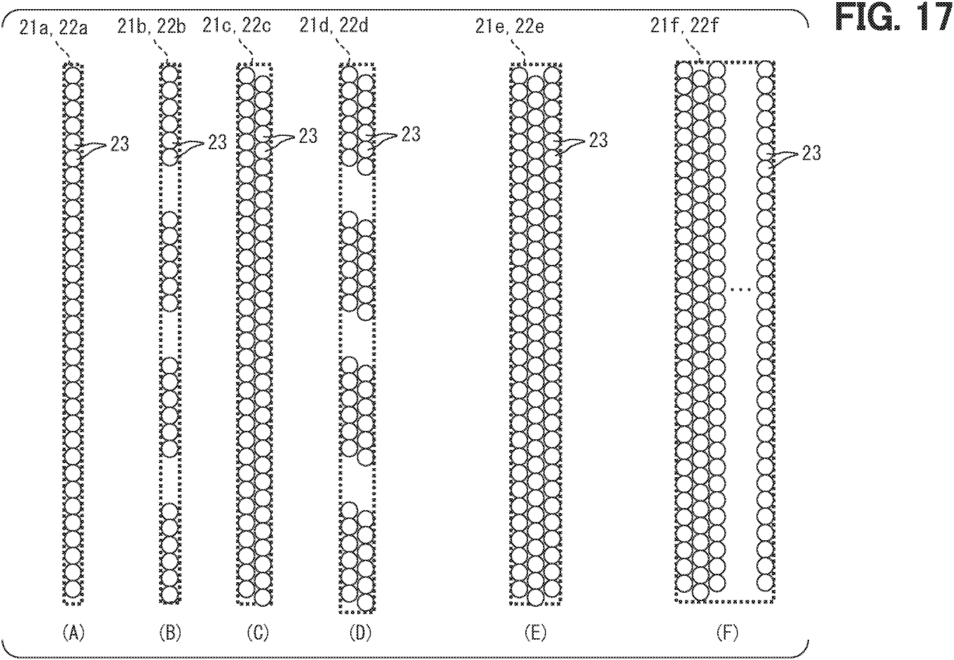

FIG. 17 shows multiple modifications of the VCSEL array 21 of the above embodiment. In a VCSEL array 21a of Modification 2, a large number of VCSEL elements 23 are arranged continuously in a single row along the longitudinal direction of a light-emitting region 22a. In a VCSEL array 21b of Modification 3, a large number of VCSEL elements 23 are arranged intermittently in a single row along the longitudinal direction of a light-emitting region 22b. In a VCSEL array 21c of Modification 4, a large number of VCSEL elements 23 are arranged continuously in two rows along the longitudinal direction of a light-emitting region 22c. In a VCSEL array 21d of Modification 5, a large number of VCSEL elements 23 are arranged intermittently in two rows along the longitudinal direction of a light-emitting region 22d. In a VCSEL array 21e of Modification 6 and a VCSEL array 21f of Modification 7, a large number of VCSEL elements 23 are continuously two-dimensionally arranged in light-emitting regions 22e and 22f. As shown in the Modifications 2 to 7 described above, the arrangement of the VCSEL elements 23 in the VCSEL array 21 can be changed as appropriate.

In Modifications 8 and 9 of the above embodiments, only one of the first optical element 61 and the second optical element 71 is provided in plurality. Specifically, the optical unit 60 of the Modification 8 includes two first optical elements 61 and one second optical element 71. Also, the optical unit 60 of the Modification 9 includes one first optical element 61 and two second optical elements 71. As described above, the number of components of the first optical element 61 and the second optical element 71 may be changed as appropriate.

In Modification 10 of the above embodiments, the first optical element 61 and the second optical element 71 are integrally formed. Specifically, the optical unit 60 of the Modification 10 is provided with one optical element (lens) that has the optical functions of the first optical element 61 and the second optical element 71. The cylindrical incident surface 62 and the cylindrical emission surface 73 are formed on such optical element. In the Modification 10 described above, it is possible to reduce the tolerance that occurs between the first optical element 61 and the second optical element 71, and it is also possible to reduce variations in the position of the composite focal plane FPF. As a result, the VCSEL elements 23 can be arranged on the composite focal plane FPF with high accuracy, thereby enabling stable formation of the projected beam PB in a clear line shape.

In Modification 11 of the above embodiments, at least one of the cylindrical incident surface 62 and the cylindrical emission surface 73 is formed in an aspherical shape. Such a lens shape makes it possible to form a clear projected beam PB by reducing aberrations.

In Modification 12 of the above embodiments, instead of the VCSEL arrays 21, edge-emitter type laser diodes are provided in the light-emitting unit 20 as a configuration corresponding to the “light emitter.” In the edge-emitter type laser diode, laser light in parallel with a semiconductor substrate is emitted from a laser emission window formed on a side surface of the semiconductor.

In Modification 13 of the above embodiments, the scanning mirror does not swing within the predetermined angular range RA, but rotates 360 degrees in one direction. In the scanning mirror of the Modification 13, reflecting surfaces are formed on both surfaces on the body of the mirror. The scanning mirror may be a mirror that performs two-dimensional scanning, such as a polygon mirror or the like.

In Modifications 14 and 15 of the above embodiments, the beam light axis BLA and the light-receiving optical axis RLA are not arranged in parallel with each other. Specifically, in the Modification 14, an inter-axis distance between the beam light axis BLA and the light-receiving optical axis RLA gradually decreases as both axes approach the reflecting surface 36 of the scanning mirror 33. On the other hand, in the Modification 15, the inter-axis distance between the beam light axis BLA and the light-receiving optical axis RLA gradually increases as both axes approach the reflecting surface 36 of the scanning mirror 33.

The first optical element 61 and the second optical element 71 in Modification 16 of the above embodiments have a power not only on the main scanning plane MS but also on the sub-scanning plane SS.

In Modification 17 of the above embodiments, an arithmetic processor corresponding to the controller 50 is provided outside the housing of the LiDAR device. The arithmetic processor may be provided as an independent in-vehicle ECU, or may be implemented as a functional unit in a drive support ECU or an automatic drive ECU. Further, in Modification 18 of the above embodiments, the function of the controller 50 is implemented as a functional section in the detector 41 of the light-receiving unit 40.

In Modification 19 of the above embodiments, the LiDAR device is mounted on a movable body different from a vehicle. Specifically, the LiDAR device may be mounted on an unmanned and movable delivery robot, drone, or the like. Further, in Modification 20 of the above embodiments, the LiDAR device is attached to a non-movable body. The LiDAR device may measure target objects such as vehicles, pedestrians and the like, in a configuration of being incorporated in a road infrastructure such as a roadside device, for example.

The processor and method described in the present disclosure may be implemented by a processing unit of a dedicated computer programmed to perform one or more functions embodied by a computer program. Alternatively, the processor and method described in the present disclosure may be implemented by dedicated hardware logic circuitry. Also, the processor and method described in the present disclosure may be implemented by discrete circuits. Alternatively, the processor and method described in the present disclosure may be realized by a combination arbitrarily chosen from among one or more processing units of a computer executing computer programs, one or more hardware logic circuits, and one or more discrete circuits. Further, the computer program may be stored in a computer-readable, non-transitory, tangible storage medium as computer-executable instructions.

What is claimed is:

1. A light detection device comprising:
a light-emitting unit including a plurality of light emitters arranged along a specific array direction and configured to emit a beam;
an optical unit positioned on an optical path of the beam emitted from the light-emitting unit and configured to form a projected beam extending along the specific array direction; and
a light-receiving unit configured to receive a return light of the projected beam projected to a measurement area, wherein
the optical unit includes:
a first optical element having a negative power along a transmission direction of the beam in a specific section that is orthogonal to the specific array direction; and
a second optical element positioned behind the first optical element and having a positive power along the transmission direction in the specific section.

2. The light detection device according to claim 1, wherein
the optical unit includes a plurality of at least one of the first optical element or the second optical element.

3. The light detection device according to claim 1, wherein
the optical unit includes a plurality of the second optical elements and a plurality of the first optical elements, and
the first optical elements are positioned before the second optical elements.

4. The light detection device according to claim 1, wherein
a front emission surface of the first optical element is in contact with a rear incident surface of the second optical element.

5. The light detection device according to claim 1, wherein
a front emission surface of the first optical element is separated from a rear incident surface of the second optical element.

6. The light detection device according to claim 1, wherein
the first optical element and the second optical element are integrally formed.

7. The light detection device according to claim 1, wherein
the optical unit further includes, before the first optical element,
a front optical element having a plurality of emission surface portions arranged along the specific array direction, each of the emission surface portions convexly curved in an orthogonal section, which is orthogonal to the specific section and along the transmission direction, toward an emission side, and
a rear optical element having a plurality of incident surface portions arranged along the specific array direction and facing to the plurality of emission surface portions, respectively, each of the incident surface portions convexly curved in the orthogonal section toward an incident side.

8. The light detection device according to claim 1, wherein
the optical unit includes
a concave cylindrical lens, as the first optical element, having a concave incident surface concavely curved toward an incident side and
a convex cylindrical lens, as the second optical element, having a convex emission surface convexly curved toward an emission side.

9. The light detection device according to claim 8, wherein
at least one of the concave incident surface or the convex emission surface is formed as an aspherical surface.

10. The light detection device according to claim 1, wherein
the light-emitting unit includes, as the light emitters, a light-emitting element array including surface-emitting laser elements formed as a two-dimensional array in a light-emitting region elongated in the specific array direction, and
each of the surface-emitting laser elements has a beam emitting surface directed in the transmission direction.

11. The light detection device according to claim 1, further comprising:
a scanning unit configured to scan the beam emitted from the light-emitting unit to project the beam to the measurement area, wherein
the scanning unit includes a rotary mirror rotatable about a rotation axis that is along the specific array direction.

12. The light detection device according to claim 10, wherein
the light-emitting unit includes a plurality of light-emitting element arrays arranged along a short direction of the light-emitting region, and
the plurality of light-emitting element arrays are configured to sequentially emit the beam in the short direction.
